(19) United States
(12) Patent Application Publication
(10) Pub. No.: US 2026/0246702 A1
(43) Pub. Date: Aug. 20, 2026

(54) SYNTHETIC NETWORK GENERATOR FOR COVERT NETWORK ANALYTICS

(71) Applicant: Rensselaer Polytechnic Institute, Troy, NY (US)

(72) Inventors: Boleslaw Karol Szymanski, Loudonville, NY (US); Amr Elsisy, Dokki (EG); Aamir Mandviwalla, Troy, NY (US)

(73) Assignee: Rensselaer Polytechnic Institute, Troy, NY (US)

(21) Appl. No.: 18/999,124

(22) Filed: Dec. 23, 2024

Related U.S. Application Data
(63) Continuation of application No. 18/776,513, filed on Jul. 18, 2024.
Application No. 18/776,513 is a continuation-in-part of application No. 17/708,212, filed on Mar. 30, 2022, now Pat. No. 12,047,243.
(60) Provisional application No. 63/168,216, filed on Mar. 30, 2021.
(60) Provisional application No. 63/286,505, filed on Dec. 6, 2021.
(60) Provisional application No. 63/286,505, filed on Dec. 6, 2021.
(60) Provisional application No. 63/324,810, filed on Mar. 29, 2022.
(60) Provisional application No. 63/613,708, filed on Dec. 21, 2023.

(51) Int. Cl. H04L 41/12; H04L 41/14

(52) U.S. Cl. CPC H04L 41/12; H04L 41/145

(57) ABSTRACT

A method of generating a synthetic network includes receiving, by a group structure identification module, anonymized input data related to an original network. The anonymized input data includes an anonymized list of nodes, a list of edges and a list of groups. The method further includes determining, by the group structure identification module, for each pair of nodes, a probability of an edge between the pair of nodes. A resulting list of probabilities corresponds to a summary group structure. The method further includes generating, by a synthetic random network generation module, at least one synthetic random network based, at least in part, on the determined probabilities.

### CROSS REFERENCE TO RELATED APPLICATION(S)

This application is a continuation-in-part of U.S. Utility patent application Ser. No. 18/776,513, filed Jul. 18, 2024 that is a continuation-in-part of U.S. Utility patent application Ser. No. 17/708,212, filed Mar. 30, 2022, which claims the benefit of U.S. Provisional Application No. 63/168,216, filed Mar. 30, 2021, U.S. Provisional Application No. 63/286,505, filed Dec. 6, 2021, and U.S. Provisional Application No. 63/324,810, filed Mar. 29, 2022, and claims the benefit of U.S. Provisional Application No. 63/613,708, filed Dec. 21, 2023, which are incorporated by reference as if disclosed herein in their entireties.

### GOVERNMENT LICENSE RIGHTS

This invention was made with government support under grant award number 2017-ST-061-CINA01, awarded by the U.S. Department of Homeland Security, contract number W911NF-17-C-0099, awarded by the Defense Advanced Research Projects Agency (DARPA) and, grant number W911NF-16-1-0524 awarded by the Army Research Office (ARO). The government has certain rights in the invention.

### FIELD

The present disclosure relates to a synthetic network generator, and, more specifically, to a synthetic network generator for covert analytics.

### BACKGROUND

Members of covert (i.e., hidden) social networks, may generally attempt to hide their membership, network structures, and activities. Such covert networks may include, but are not limited to, terrorist and criminal networks. Thus, data about covert networks is often incomplete and/or partially incorrect, making interpreting structures and activities of such networks challenging. Additionally, or alternatively, actual data about active covert networks may generally be inaccessible to, for example, researchers.

### SUMMARY

In an embodiment, there is provided a method of generating a synthetic network. The method includes receiving, by a group structure identification module, anonymized input data related to an original network. The anonymized input data includes an anonymized list of nodes, a list of edges and a list of groups. The method further includes determining, by the group structure identification module, for each pair of nodes, a probability of an edge between the pair of nodes. A resulting list of probabilities corresponds to a summary group structure. The method further includes generating, by a synthetic random network generation module, at least one synthetic random network based, at least in part, on the determined probabilities.

In some embodiments, the method further includes classifying, by the group structure identification module, each edge into a selected class, and generating, by the group structure identification module, a corresponding randomized weight for each class separately.

In some embodiments of the method, the original network is selected from the group including an actual network or another synthetic network.

In some embodiments of the method, the generating at least one synthetic random network corresponds to generating a set of synthetic random networks that are statistically similar.

In some embodiments, the method further includes generating, by a data anonymization module, the anonymized input data.

In some embodiments of the method, the anonymized input data further includes incorrect data related to the original network.

In some embodiments of the method, the list of nodes includes a plurality of node records. Each node record includes a unique node identifier and a management hierarchy indicator. The list of edges includes a plurality of edge records. Each edge record includes a starting node identifier, an ending node identifier, and an edge weight. The list of groups includes at least one group record. Each group record includes a list of node identifiers corresponding to members of the group.

In some embodiments, the method further includes assigning, by the group structure identification module, a randomized weight to each weighted edge using at least one of a weighted random graph technique and/or a Bernoulli weighted random network technique.

In some embodiments of the method, the generating at least one synthetic random network corresponds to an extension of a Stochastic block model.

In some embodiments, the method further includes assigning, by the group structure identification module, a management role to a selected node.

In an embodiment, there is provided a synthetic network generator system for covert networks. The system includes a group structure identification module configured to receive anonymized input data related to an original network. The anonymized input data includes an anonymized list of nodes, a list of edges and a list of groups. The group structure identification module is further configured to determine, for each pair of nodes, a probability of an edge between the pair of nodes. A resulting list of probabilities corresponds to a summary group structure. The system further includes a synthetic random network generation module configured to generate at least one synthetic random network based, at least in part, on the determined probabilities.

In some embodiments of the system, the group structure identification module is further configured to classify each edge into a selected class, and to generate a corresponding randomized weight for each class separately.

In some embodiments of the system, the original network is selected from the group including an actual network or another synthetic network.

In some embodiments of the system, the generating at least one synthetic random network corresponds to generating a set of synthetic random networks that are statistically similar.

In some embodiments, the system further includes a data anonymization module configured to generate the anonymized input data.

In some embodiments of the system, the anonymized input data further includes incorrect data related to the original network.

In some embodiments of the system, the list of nodes includes a plurality of node records. Each node record includes a unique node identifier and a management hierarchy indicator. The list of edges includes a plurality of edge records. Each edge record includes a starting node identifier, an ending node identifier, and an edge weight. The list of groups includes at least one group record. Each group record includes a list of node identifiers corresponding to members of the group.

In some embodiments of the system, the group structure identification module is configured to assign a randomized weight to each weighted edge using at least one of a weighted random graph technique and/or a Bernoulli weighted random network technique.

In some embodiments of the system, the generating at least one synthetic random network corresponds to an extension of a Stochastic block model.

In some embodiments of the system, the group structure identification module is configured to assign a management role to a selected node.

In an embodiment, there is provided a method of generating a synthetic network variant. The method includes generating, by a preprocessor module, a set of r generated networks based, at least in part, on noisy network structure data. The method further includes identifying, by the preprocessor module, at least one nonoverlapping community in each generated network. Each community has an associated community structure. The method further includes grouping, by the preprocessor module, the generated networks into a number, s, of groups based, at least in part, on a respective community structure. Each member of a respective group contains the respective community structure. The method further includes determining, by the preprocessor module, a respective probability for each community structure. Each probability is related to a respective estimated ground truth community structure.

In some embodiments of the method, the probability is modeled as a ratio of a size of a respective group to the number, r, generated networks. The size corresponding to a weight associated with the corresponding community structure.

In some embodiments of the method, the community structure associated with a largest respective probability corresponds to an estimated ground-truth community structure.

In some embodiments of the method, the community structure having the largest respective probability corresponds to a lowest entropy community structure.

In some embodiments, the method further includes identifying, by a network variant module, a community structure configured to minimize an expected cost of operating on a network having uncertainty in at least one of an associated community structure and/or a node function.

In some embodiments, the method further includes generating, by a network pool generator module, a plurality of sets of intermediate networks based, at least in part, on a set of input networks. Each input network includes a community structure having a highest estimated probability of corresponding to a ground truth community structure.

In some embodiments, the method further includes generating, by a network pool generator module, a set of intermediate networks based, at least in part, on an input network. The input network includes a community structure having a highest estimated probability of corresponding to a ground truth community structure.

In some embodiments of the method, the input network has been selected from a set of input networks. The selected input network has a highest modularity relative to other input networks included in the set of input networks.

In some embodiments of the method, the identifying the community structure configured to minimize an expected cost includes at least one of a frequency-based penalty and a fraction-based penalty.

In some embodiments of the method, the identifying the community structure configured to minimize an expected cost includes iteratively merging a pair of candidate communities to yield a new candidate community and determining a penalty change associated with the merger.

In an embodiment, there is provided a computer readable storage device. The device has stored thereon instructions that when executed by one or more processors result in the following operations including generating a set of r generated networks based, at least in part, on noisy network structure data; and identifying at least one nonoverlapping community in each generated network. Each community has an associated community structure. The operations further include grouping the generated networks into a number, s, of groups based, at least in part, on a respective community structure. Each member of a respective group contains the respective community structure. The operations further include determining a respective probability for each community structure. Each probability is related to a respective estimated ground truth community structure.

In some embodiments of the device, the probability is modeled as a ratio of a size of a respective group to the number, r, generated networks. The size corresponds to a weight associated with the corresponding community structure.

In some embodiments of the device, the community structure associated with a largest respective probability corresponds to an estimated ground-truth community structure.

In some embodiments of the device, the community structure having the largest respective probability corresponds to a lowest entropy community structure.

In some embodiments of the device, the instructions that when executed by one or more processors result in the following operations including identifying a community structure configured to minimize an expected cost of operating on a network having uncertainty in at least one of an associated community structure and/or a node function.

In some embodiments of the device, the instructions that when executed by one or more processors result in the following operations including generating a plurality of sets of intermediate networks based, at least in part, on a set of input networks, each input network including a community structure having a highest estimated probability of corresponding to a ground truth community structure.

In some embodiments of the device, the instructions that when executed by one or more processors result in the following operations including generating a set of intermediate networks based, at least in part, on an input network. The input network includes a community structure having a highest estimated probability of corresponding to a ground truth community structure.

In some embodiments of the device, the input network has been selected from a set of input networks. The selected input network has a highest modularity relative to other input networks included in the set of input networks.

In some embodiments of the device, the identifying the community structure configured to minimize an expected cost includes at least one of a frequency-based penalty and a fraction-based penalty.

In some embodiments of the device, the identifying the community structure configured to minimize an expected cost includes iteratively merging a pair of candidate communities to yield a new candidate community and determining a penalty change associated with the merger.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a synthetic network generator system for covert network analytics, according to several embodiments of the present disclosure;

FIG. 2 is a flowchart of synthetic network generation operations, according to various embodiments of the present disclosure;

FIG. 3 illustrates a functional block diagram of a synthetic network generator system for network analytics, according to several embodiments of the present disclosure;

FIG. 4 is a flowchart of preprocessing operations, according to various embodiments of the present disclosure;

FIG. 5 is a flowchart of network variant operations, according to various embodiments of the present disclosure; and

FIG. 6 is a flowchart of network pool generation operations, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

A common trait of covert networks is that members generally try to hide their membership structure and, for criminal or terrorist networks, their illegal activities. The membership in such networks is often secretive. Their relatively important interactions may be covert, so their relatively unimportant interactions may seem overly visible, possibly masking relatively important interactions. Law enforcement is generally constrained in their methods of collecting data by, for example, privacy laws. As a result, the data about covert networks may be incomplete and/or at least partially incorrect. Thus, interpreting or discerning the structure and activities of such networks may be particularly challenging. Additionally, or alternatively, data about networks under investigations may be inaccessible to researchers.

Generally, a method, apparatus, and/or system, according to the present disclosure, is configured to generate a set of synthetic networks, with each synthetic network structurally similar to an original network. In an embodiment, the original network may correspond to an actual network. In another embodiment, the original network may correspond to another synthetic network. Members of an actual network may be individuals and each individual may correspond to a node in a synthetic network. Each synthetic network may contain a plurality of anonymous nodes that are interconnected or clustered similar to, but slightly different from, the nodes in the original network. In one nonlimiting example, the synthetic networks may then be used to train research and/or analytical tools for finding structure and/or dynamics of actual covert networks.

The synthetic networks may support a plurality of alternative interpretations of the data regarding the original network. A distribution of probabilities for the alternative interpretations may enable users of the data to quantify statistically expected outcomes of operations on the covert networks. The distribution of probabilities for the alternative interpretations may provide an indication whether the data collected for selected covert network is sufficient for reliably interpreting the selected network's structure and/or dynamics. For example, a relatively high frequency of alternative interpretations of the original network structure may make them relatively more likely candidates for ground truth structure. Additional data may then support a determination of which interpretation relatively more likely corresponds to a true structure of the original network.

In another example, the generated synthetic networks, according to the present disclosure, may be useful for analyzing the social networks with partial information about their structures. In another example, the generated synthetic networks, according to the present disclosure, may be useful for analyzing biomedical networks in which a massive collection of experimental data about network dynamics may include data that is at least partially incomplete and/or at least partially incorrect.

It may be appreciated that discovery and monitoring of covert networks often rely on getting access to information flows among nodes, e.g., individuals, suspected to be involved in network activities. This flow may involve one or more of wiretapped telephone interactions, message exchanges, recorded conversations, or copies of written documents. A covert organization may be represented by a covert network. A node that is included in the covert network may correspond to a member of the covert organization. Using community detection, a covert network may include groups of members who interact among themselves more often than with other members. In small organizations, groups may be independent of the organizational structure of the network, or they may have a hierarchical structure for management nodes. The number of hierarchy levels may be related to the organization size. As used herein, each group may be represented by one or more group parameters. Group parameters may include, but are not limited to, average density of edges inside the group, average density of edges from a selected group to other groups, and a respective placement of each group member in an organization hierarchy. As used herein, an edge corresponds to a connection between two nodes. The connection may represent communication (e.g., telephone call, conversation captured via surveillance). For example, one or more group parameters may be used to individualize group leader connections to members of its group, and/or separately, to other nodes. Given an original network, a synthetic network generator, according to the present disclosure, is configured to individualize the original network by randomly rewiring edges of its groups and its management hierarchy. Thus, a synthetic network generator, according to the present disclosure, may be configured to combine two network models: a stochastic block model (SBM) for groups and a hierarchical network for management structure.

It may be appreciated that acquiring data for actual covert organizations may rely on intercepting communications and/or on surveillance, of identified members of a selected organization. Acquired data may include, but is not limited to, records of telephone calls between organization members, that may include timing, frequency, call initiator identifier, call recipient identifier, for each telephone call, etc., records from conversation surveillance, that may include timing, frequency, respective participant identifier for each participating group member, etc. Network nodes may then correspond to call initiators and call recipients and/or conversation participants, and an edge weight may correspond to a number of calls (and/or a number of conversations) between two selected nodes during a defined time period, e.g., a number of months. Acquired or known data may further include events affecting the organization, e.g., associated interdiction, movement of member(s) within a management structure of an organization. The data may be collected over a time period and/or as snapshots in time at each of a plurality of time intervals. Fewer than all members of an organization may be identified.

It may be further appreciated that based, at least in part, on acquired organization data, one or more groups and/or one or more managers may be identified. In one nonlimiting example, a Louvain method for community detection may be used to extract one or more groups from organization data and a relative betweenness centrality may be used to find nodes involved in managerial roles. It may be appreciated that criminal networks may have sparse connectivity because of attempts to hide network activities, thus, a Louvain technique configured for graphs with undirected edges may be used. However, this disclosure is not limited in this regard. Other community detection techniques may include, but are not limited to, SpeakEasy community detection, constant Potts model (CPM), modularity maximization, fast modularity, adaptive modularity, etc.

Continuing with the Louvain technique, directed edges of the generated networks may be transformed into undirected ones, summing their weights for pairs of nodes which have two opposing edges connecting them. Covert networks may prioritize either efficiency or security, but generally not both. The betweenness centrality of a node is a measure of a fraction of the shortest paths of information flow between all pairs of nodes passing through this node. A normalized version of this metric, called relative betweenness centrality, limits its range to [0,1]. The normalized version may facilitate comparison of the results between groups and/or organizations.

In an embodiment, a network generation process for a Random Anonymized Network Generator (RANG) may be configured to generate a network. In an embodiment, the RANG may be organized into a plurality (e.g., three) of sets of operations. The sets of operations may include, but are not limited to, data anonymization, group structure identification, and synthetic random network generation. As used herein, the labels for sets of operations are labels of convenience and not of limitation, thus, this disclosure is not limited in this regard. A first set of operations (“data anonymization”), may be performed by, and/or under control of, a source (e.g., owner) of the original network data. Data anonymization operations are configured to anonymize (i.e., remove identifying information regarding) network node data. Data anonymization operations may include assigning a unique node identifier (ID) to each node. In one nonlimiting example, the unique node ID may be numeric. The unique node identifier is configured to replace each node identity and corresponding personal data by a unique ID of this node, that provides or preserves anonymity of the group member, manager or boss, corresponding to the node. Data anonymization operations may further include assigning to each node its respective place in the management hierarchy and a group to which this node belongs. In one nonlimiting example, each group may be identified by a respective group ID, that may be numeric or alphanumeric. Data anonymization operations may include generating, for each node, a list of subordinate node(s) and a list of superior node(s). The subordinate and/or superior nodes may be represented by their respective unique node IDs. It may be appreciated that, for some nodes, the list of subordinate node(s) and/or the list of superior node(s) may be null, i.e., may not include any other node IDs. Thus, node identifying information may be removed, and network organization structure may be summarized.

A second set of operations (group structure identification) may be performed by a RANG module. Group structure identification operations are configured to summarize a group structure of a network. In an embodiment, the group structure of the network may be summarized as a list of probabilities of an edge between any pair of nodes. These probabilities are related to the group(s) to which the nodes belong and the roles these nodes play in the network. For example, each pair of nodes may have a corresponding respective probability of an edge coupling the two nodes in the pair of nodes. The obtained data may be shared with the outside users or used internally by the owners.

The third set of operations (synthetic random network generation) is configured to generate a set of synthetic random networks. The synthetic random network generation may utilize one or more of the edge probabilities generated by the group structure identification operations. The third set of operations may include analyzing the set of synthetic random networks for a group structure stability. The third set of operations may further include analyzing the set of synthetic random networks to evaluate each node's management role(s) consistency.

It may be appreciated that social networks may have directed weighted edges configured to represent intensity of interactions. Intensity of interactions may be measured, for example, in frequency of calls, messages, or meetings. Weights may be assigned to edges by one or more techniques. Weight assignment techniques may include, but are not limited to a Weighted Random Graph (WRG) generator, and/or Bernoulli Weighted Random Network (BWRN) model.

In the Weighted Random Graph (WRG) generator, an edge's weight may be generated by running Bernoulli trials with probability p=W/(W+E), where W is a sum of the weights of all edges and E is a maximum number of edges that may be generated between subsets of nodes. As is known, a Bernoulli trial is a random experiment with exactly two possible outcomes, “success” or “failure”, and in which the probability of success is the same every time the experiment is conducted (i.e., run). A run stops at a first failed trial. A number of successful trials before this first failure may then define a corresponding weight of the generated edge. The WRG generator process is configured to yield a geometric distribution of edge weights.

The Bernoulli Weighted Random Network (BWRN) technique (i.e., model) may include two parameters. A first BWRN parameter corresponds to a vector of the weights, w's, for the edges in the original graph. A second BWRN parameter corresponds to a probability p_{B} that controls a variance of the generated weight distribution. The BWRN process of generating edges may start with the relatively heaviest edges and progress down to edges with the relatively smallest weight. Given a currently processed weight w, an associated weight may be determined as w_{B}=└w/p_{B}┘. For each edge with weight w in the original graph, a weight in the range [0, └w/p_{B}┘] may be selected as follows. First, a pair of not yet connected nodes is randomly selected and w_{B} Bernoulli trials are run with probability p_{B}. If p_{B}w_{B}<w, one more Bernoulli trial is run, with probability pₐ=w−p_{B}w_{B}. The weight from such a run is equal to the number of successes in those trials. An edge is not created when this run returns weight 0.

The BWRN technique is configured to yield a distribution of weights with probability of choosing weight k (where 0≤k≤┌w/p_{B}┐) defined as:

$${p}_{w} ( k , {p}_{B} ) = \{ \begin{matrix}\frac{( w ) !}{( w - k ) ! k !} {{p}_{B}^{k} ( 1 - {p}_{B} )}^{w - k} if k \leq {w}_{B} \\ w - {p}_{B} {w}_{B} for k = {w}_{B} + 1 if {p}_{B} {w}_{B} < w\end{matrix} \qquad ( 1 )$$

Thus, an average sum of weights of all edges created by this technique may be the same as in the original network because the expected weight from Equation 1 is p_{B}w_{B}+w−p_{B}w_{B}=W.

The parameter p_{B} defines probability that the edge of weight w will not be generated, which is (1−p_{B})^{w} if w=p_{B}w_{B} and (1−p_{B})^{w}(1−w+p_{B}w) otherwise, so it quickly decreases with increase of w and p_{B}. For example, with p_{B}>0.9, edges with weight 1 have a relatively low chance (i.e., below 1%) to be lost. A trade-off may arise for slightly lower values of p_{B}. For example, with p_{B}=0.875, about 10% of such edges will not appear in the generated network, but a similar fraction of edges may increase their weight to 2, thus, strengthening a cohesiveness of some communities.

A variance of the distribution of the weights generated for an edge with weight w in the original data is w(1−p_{B})+pₐ(p_{b}−pₐ)≈w(1−p_{B}), so it grows with increase in w but decays with increase of p_{B}. Thus, selecting large p may make generated synthetic networks more similar to the original network, while decreasing p_{B} may have opposite effects. Hence, different kinds of analyses may be conducted with different choices of p_{B}.

By taking into account weights of edges, the BWRN model is configured to allow a user to define different edge densities in a group for edges at a same level of hierarchy (e.g., among peers) than for edges across the hierarchy (e.g., between the group leader and a subordinate). The user may thus account for typically higher information flow intensities between managers and subordinates than among peers.

Thus, weights may be assigned to edges.

It may be appreciated that network hierarchy levels may be detected to reveal the structural properties of the generated networks. The relative betweenness centrality may be used as a hierarchy level measure because in networks there is a strong correlation between the hierarchy measures and betweenness centrality scores. Comparing the nodes with high relative betweenness centrality in a generated network and such nodes in a corresponding original network are configured to support generating a measure how well the generated networks preserve leadership hierarchy. A Combined Score (CS) measures overall similarity of generated networks to the original network. CS is a product of the group and hierarchy similarities.

In an embodiment, there is provided a method of generating a synthetic network. The method of generating a synthetic network includes receiving, by a group structure identification module, anonymized input data related to an original network. The anonymized input data includes an anonymized list of nodes, a list of edges and a list of groups. The method further includes determining, by the group structure identification module, for each pair of nodes, a probability of an edge between the pair of nodes. A resulting list of probabilities corresponds to a summary group structure. The method further includes generating, by a synthetic random network generation module, at least one synthetic random network based, at least in part, on the determined probabilities.

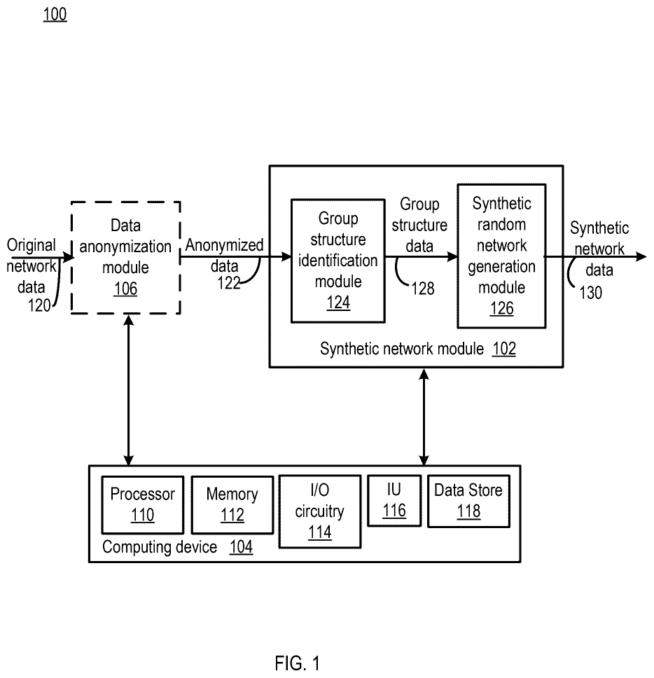

FIG. 1 illustrates a functional block diagram of a synthetic network generator system 100 for covert network analytics, according to several embodiments of the present disclosure. Synthetic network generator system 100 includes a synthetic network module 102, a computing device 104, and may include a data anonymization module 106. Synthetic network module 102 and/or data anonymization module 106 may be coupled to or included in computing device 104. Synthetic network module 102 includes a group structure identification module 124, and a synthetic random network generation module 126.

Generally, the synthetic network generator system 100 for covert network analytics is configured to receive original network data that may include actual network data or synthesized network data. The actual network data may correspond to proprietary network data. The actual network data may be anonymized, an associated network structure may be determined, and a plurality of corresponding synthetic networks may be generated, that may then be used to analyze operation of the network(s).

The data anonymization module 106 is configured to receive original network data 120, and to provide anonymized data 122 as output. The synthetic network module 102 (e.g., group structure identification module 124) is configured to receive the anonymized data 122. The group structure identification module 124 is configured to provide group structure data 128. The synthetic random network generation module 126 is configured to receive the group structure data 128. The synthetic network module 102 (e.g., synthetic random network generation module 126) is configured to provide the synthetic network data 130.

Computing device 104 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 104 includes a processor 110, a memory 112, input/output (I/O) circuitry 114, a user interface (UI) 116, and data store 118.

Processor 110 is configured to perform operations of synthetic network module 102 and/or data anonymization module 106. Memory 112 may be configured to store data associated with synthetic network module 102 and/or data anonymization module 106. I/O circuitry 114 may be configured to provide wired and/or wireless communication functionality for synthetic network generator system 100. For example, I/O circuitry 114 may be configured to receive original network data 120 and to provide synthetic network data as output 122. In another example, I/O circuitry 114 may be configured to receive or provide anonymized data 122. UI 116 may include a user input device (e.g., keyboard, mouse, microphone, touch sensitive display, etc.) and/or a user output device, e.g., a display. Data store 118 may be configured to store one or more of original data 120, anonymized data 122, group structure data 128, and/or synthetic network data 130. Data store 118 may be configured to store network parameters associated with group structure identification module 124 and/or synthetic network generation module 126, and/or data associated with data anonymization module 106.

In operation, the synthetic network generator system 100 for covert network analytics may be configured to perform a set of operations, configured to generate a plurality of synthetic network data sets. In an embodiment, the sets of operations may include, but are not limited to, data anonymization, group structure identification, and synthetic random network generation.

A first set of operations may be performed by the data anonymization module 106. The anonymization module 106 is configured to receive original network data 120 that may not be anonymized. The anonymization module 106 may be further configured to anonymize the received original network data 120 to produce anonymized data 122. The anonymized data 122 may then be provided to the synthetic network module 102.

The first set of operations (“data anonymization”), may be performed by, and/or under control of, a source (e.g., owner) of the original network data, as described herein. The original network may be an actual network or a synthetic network. In an embodiment, the input data, i.e., anonymized data 122, corresponding to the original (actual or synthetic) network may be provided, by or under control of the source. As used herein, input data corresponds to anonymized data, e.g., anonymized data 122.

In an embodiment, the input data 122 may be configured as a plurality of lists that contain (anonymized) data about the original network. In one nonlimiting example, the input data may include three lists about this network. The input data is configured to be anonymized, thus, personal information about the nodes may be removed. The input data may thus include the plurality of lists of nodes. A first list may include a plurality of node records, with each record representing a node, and each record including a unique abstract (e.g., numeric) node identifier and a management hierarchy indicator corresponding to a level of management hierarchy to which this node belongs. A second list may include a plurality of records corresponding to the edges in the original network. Each edge record may include a starting node identifier corresponding to the starting node, an ending node identifier corresponding to the ending node, and an edge weight, for the edge. A third list may include one or more records corresponding to groups in the original network. Each group record may include a list of identifiers (i.e., node identifiers) corresponding to members of the group. The group membership may be determined based, at least in part, on the original network. A group record may further include a node identifier associated with a group leader flag, configured to identify a group leader. It may be appreciated that some groups may not have a group leader. As used herein, a group that does not include a group leader is considered to be independent. In an embodiment, the input data may correspond to a synthetic network, generated by, or under control of the owner(s) of the actual network data. The input synthetic network data may thus be in an appropriate format and the generated network may be different from the original, preserving anonymity.

A next (i.e., second) set of operations may be performed by the group structure identification module 124. The group structure identification module 124 is configured to receive the anonymized data 122, and to identify a group structure and to produce corresponding group structure data 128. The group structure data 128 may then be provided to the synthetic random network generation module 126.

The next set of operations may include group structure identification operations, performed by, for example, the group structure identification module 124. Group structure identification operations may begin with processing the input data (i.e., anonymized data 122) to determine a respective probability of existence and respective weight for each edge for a generated network. Operations may include assigning a randomized weight to each weighted edge. In an embodiment, the random weights may be assigned according to a model. The model may be selected from the group including a WRG technique, and a BWRN technique, as described herein.

The group structure identification operations may include classifying the edges into a plurality of classes and generating edges and weights for each class separately. A first class of edges may include internal edges of a group gᵢ of size |gᵢ| at a same level of management hierarchy. In other words, the first class is configured to include members, but not superiors, that are neighbors. The first class may thus include Eⁱ=|gᵢ| (|gᵢ|−1) directed edges. A sum of the weights of the directed edges may be denoted as Wⁱ. A second class of edges may be configured to include edges across the members of two different groups gᵢ, gⱼ. The second class may thus include E^{i,j}=|gᵢ∥gⱼ| such edges from gᵢ to gⱼ and E^{i,j} in the opposite direction, i.e., going from gⱼ to gᵢ. Sums of weights of the second class of edges may be denoted as W^{i,j}, W^{j,i}. A third class of edges may include edges from a superior, s(i) to the members of its group gᵢ and from the group members to this superior. The third group of edges may thus include E^{s(i),i}=E^{i,s(i)}=|gᵢ| of such edges in each direction. Sums of weights of the third class of edges may be denoted as W^{s(i),i}, W^{i,s(i)}. A number of all nodes not in a group gᵢ at the level of management of members of this group may be denoted as |¬i|. The class of edges from the superior of group i to ¬i nodes may be defined as E^{s(i),¬i}=|¬i| in each direction, with the sum of weights denoted W^{s(i),¬i}.

In one example, the Weighted Random Graph (WRG) approach may be used, as described herein. In another example, the Bernoulli Weighted Random Network (BWRN) technique may be used, as described herein.

The group structure identification operations may include assigning management roles to selected node(s). An arbitrary number of management hierarchy levels may be assigned. It may be appreciated that some networks may include relatively small groups. In one nonlimiting example, a maximum number of hierarchy levels may be three. However, this disclosure is not limited in this regard. A number of nodes assigned to each hierarchy level greater than one may be related to a total number of groups at an immediately lower level. For example, for a maximum number of hierarchy levels of three, a third level of management corresponds to a relatively highest authority node in a corresponding local network. As used herein, a “boss” corresponds to a highest authority node. As used herein, a manager corresponds to a node at a second level, i.e., one level below the highest authority node. The first level of hierarchy may then include the remaining nodes organized into groups. As used herein, the remaining nodes, at the first level of hierarchy, are members. In some embodiments, a network generator, according to the present disclosure, may be configured to find group managers, without any information from network investigators, i.e., without corresponding information from the actual network. It may be appreciated that managers may serve as intermediaries between the boss and the members. In one nonlimiting example, a relatively small company may have a ratio of four employees per manager. In another nonlimiting example, a covert network may have a ratio of close to six. It is contemplated that reasons for this difference may include self-motivation of the members for doing their tasks, and/or limiting a fraction of the organization members interacting with the boss for safety reasons.

It may be appreciated that not all groups may be supervised through hierarchical management. As used herein, a group that is not supervised through hierarchical management is independent. A group of relatively small size and with a relatively low fraction of reciprocal connections is relatively more likely to be independent. In one nonlimiting example, a group whose members have only outgoing edges targeting outside nodes may be independent. Thus, members of an independent group may not have incoming edges from any other node in the network.

Thus, the group structure identification module 124 may be configured to receive the anonymized input data 122, to perform group structure identification operations, as described herein, and to produce group structure data 128 as output.

A next (i.e., third) set of operations may be performed by the synthetic random network generation module 126. The synthetic random network generation module 126 is configured to receive group structure data 128, and to perform the synthetic random network generation operations to produce the synthetic network data 130. The synthetic network data 130 may then be used to analyze one or more synthetic networks that correspond to the original network.

The next (i.e., third) set of operations may further include synthetic random network generation operations. In an embodiment, synthetic random network generation operations may correspond to an extension of a stochastic block model (SBM). The extension may include support for weighted directed edges with integer weights. Inputs for the synthetic random network generation operations may include lists of network nodes, lists of edges with integer weights, and lists of groups in the original network, as described herein. A first operation in the set of synthetic random network generation operations may include counting, for each group, a sum of weights of all edges inside the group. The operations may further include counting edges of the group leading to and from each other group. Probabilities based, at least in part on the sums may be determined by dividing each the sum of weights of all edges inside the group by a sum of weights of all the network edges. In one nonlimiting example, a numpy random choice technique may be used, by a baseline generator to select a pair of groups, including those in which the source and target groups are the same. It may be appreciated that the numpy random choice technique may be configured to select random samples of a one-dimensional array. However, this disclosure is not limited in this regard. A node from the source group and a node from the target group may then be selected repeatedly until the selected nodes are different. Thus, self-loops may be avoided. A probability, for the selected group, may then be selected from the created set of probabilities. A Bernoulli trial may then be executed with the selected probability. On success of the trial, the weight of connection between these two nodes may be increased by one. The entire process may be repeated until the total weight of all edges becomes the same as in the input network. In some embodiments, a Louvain community detection may be run on the resulting network and the output may be compared the output with the original network communities, e.g., to test the model.

Thus, a method, apparatus, and/or system, according to the present disclosure, is configured to generate a set of synthetic networks, with each synthetic network structurally similar to an original network. Each synthetic network may contain a plurality of anonymous nodes that are interconnected or clustered similar to, but slightly different from, the nodes in the original network. In one nonlimiting example, the synthetic networks may then be used to train research and/or analytical tools for finding structure and/or dynamics of actual covert networks.

The synthetic networks may support a plurality of alternative interpretations of the data regarding the original network. A distribution of probabilities for the alternative interpretations may enable users of the data to quantify statistically expected outcomes of operations on the covert networks. The distribution of probabilities for the alternative interpretations may provide an indication whether the data collected for selected covert network is sufficient for reliably interpreting the selected network's structure and/or dynamics. For example, a relatively high frequency of alternative interpretations of the original network structure may make them relatively more likely candidates for ground truth structure. Additional data may then support a determination of which interpretation relatively more likely corresponds to a true structure of the original network.

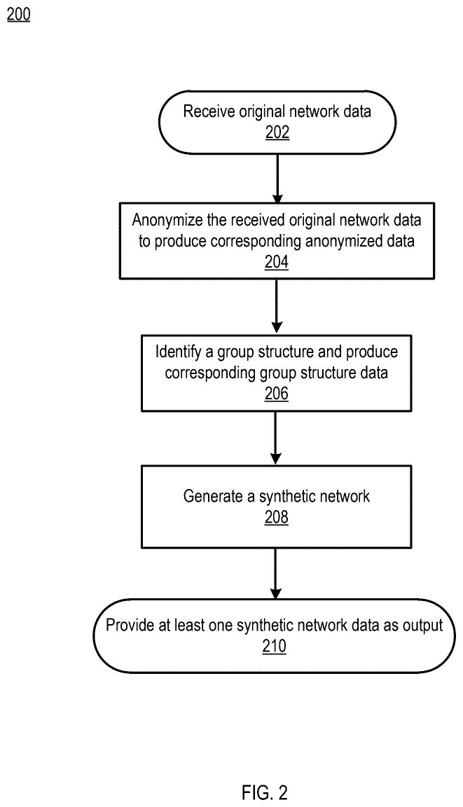

FIG. 2 is a flowchart 200 of synthetic network generation operations, according to various embodiments of the present disclosure. In particular, the flowchart 200 illustrates anonymizing original network data, identifying a group structure and generating a set of synthetic networks based, at least in part, on the original network data. The operations may be performed, for example, by the synthetic network generator system 100 (e.g., data anonymization module 106, group structure identification module 124 and/or synthetic random network generation module 126) of FIG. 1.

Operations of this embodiment may begin with receiving original network data at operation 202. The original network data may be actual network data or synthetic network data. Operation 204 includes anonymizing the received original network data to produce corresponding anonymized data. Operation 206 includes identifying a group structure and producing corresponding group structure data. Operation 208 includes generating a synthetic network. At least one synthetic network data may be provided as output at operation 210.

Thus, at least one synthetic network may be generated based, at least in part, on original network data that may be anonymized.

In the following, the terms “community” and “community structure” correspond to the terms “group” and “group structure” in the prior description above. Thus, definitions of group, and/or group structure, and their associated parameters (e.g., node, edge, hierarchy, etc.) correspond to community, community structure and their associated parameters in the following.

It may be appreciated that, mapping network nodes and edges to communities and network functions may be useful for gaining a higher level of understanding of the network structure and functions. Such mappings are challenging to design for covert social networks, which intentionally hide their structure and functions to protect important members from attacks or arrests. Structures and functions of such networks may be inferred, as will be described in more detail below. It may be further appreciated that techniques, according to the present disclosure may be relatively broadly applied.

Without a known ground truth, i.e., knowledge about allocation of nodes to communities and network functions, a single network based on the noisy data may be unable to represent all plausible communities and functions of an underlying network. In an embodiment according to the present disclosure, a generative model may be applied configured to randomly distort an original network based on the noisy data, and to thus generate a pool of statistically equivalent networks. Each unique generated network may be recorded, and each duplicate of a previously recorded network increases the repetition count associated with that network. Each such network may be treated as a variant of the ground truth with a probability of the variant arising in the real world approximated by a ratio of a count of this network's duplicates plus one (to account for the first recorded network) to a total number of all generated networks. Communities of variants with relatively frequently occurring duplicates may contain persistent patterns shared by their structures. Using Shannon entropy, a variant may be identified that is configured to minimize an uncertainty for operations planned on the network. Repeatedly generating new pools of networks from a relatively best network of a previous step for several steps may lower the entropy of the best new variant. If the entropy is too high, a network operator can identify nodes, the monitoring of which can achieve the most significant reduction in entropy. In an embodiment, a heuristic may be configured for constructing a new variant, which is not randomly generated but has the lowest expected cost of operating on the distorted mappings of network nodes to communities and functions caused by noisy data.

An amount of data collected in the world has grown exponentially for at least the last decade, including data on covert networks. To capitalize on such network data, access to it may be supplemented with tools capable of curating data and extracting key results. The analysis of real-world networks may overcome errors recorded in the network data that occur during the acquisition process. For small datasets it may be possible to correct these errors manually, but this is generally not feasible for large datasets, especially when edges are purposefully added or disguised by actors in the network. In an embodiment, a method of analyzing networks created from data with unintentional or intentional errors is disclosed, configured to improve downstream extraction of network features.

By way of theoretical background, sources of noise in network data can be classified into a number of categories. A first source of noise may originate from monitoring relations that are not directly observable, so collected data are a proxy of the desired relationships. In the context of social networks, an example of this corresponds to relatively frequent communication between two people which may imply a trust relationship between them. To illustrate the potential shortcomings of such proxies, it may be observed that some of the calls might be strictly professional or even an indication of disagreement and distrust rather than trust. Similarly, in a biological network context, proxies may be relied on for protein interactions (their physical binding) in artificial testing systems. These proxies can produce many false positives, as bound proteins might not actually be found in the same place or at the same time within their originating cell.

A second category of noisy data may be caused by deliberate distortion or attempts to conceal some characteristics of the network, or even its entire existence, undertaken by the nodes of such a network. One example of this category of noise is covert networks, where members of the network may be intentionally hiding their involvement and interactions by avoiding communicating within the network in cases when the only available means of communication can be easily tracked, such as cell phones with registered ownership. To avoid detection of their interactions within crime organizations, the criminals may use wiretapped phones only for private conversations. In many networks with massive data collections, a third category of sources of data noise is the presence of a low but persistent rate of erroneous experimental measurements that distort the valid results.

The presence of noise in network data distorts the detection of network edges, which is likely to modify the network's community structure. In the absence of the ground-truth data about basic properties of the network, including, for example, allocation of nodes to communities and to network functions, an operation designed based on a single network derived from such data may not be able to predict all distortions that can arise during such an operation.

Generally, this disclosure relates to preprocessing operations that are applied to collected noisy network data, three entropy-based metrics, and two heuristics, each of which constructs a community structure for a given network while minimizing the expected cost arising from operating on networks with communities and functions distorted by using noisy data for their creation.

Using the Bernoulli weighted random network (BWRN) algorithm, as described herein, a set of r networks may be generated from given noisy network data and their non-overlapping communities may be identified. These networks may then be grouped (i.e., clustered) into s≤r groups of networks that share the same community structure. Because the network community structures are configured to be robust to relatively minor edge perturbation, for relatively large r and with s<r, a ratio of the size of each cluster to r may approximate a probability that the corresponding structure is the ground truth. In an embodiment, three entropy-based metrics, adapted from human mobility entropy models, may be used to quantify an uncertainty of a community structure and its corresponding level of predictability.

As will be described in more detail below, given the unavailability of the ground truth, using a single network derived from noisy data may not be capable of predicting all distortions in the underlying data. In an embodiment, a generator may be applied configured to rewire networks using a combination of the Stochastic Block Model (SBM), and hierarchical model, as described herein. As used herein, “rewire” corresponds to generating a set of networks from a given network. The SBM may be useful due to its ability to limit changes to the community structure of the generated network, while a hierarchical model is configured to help preserve a network's member hierarchy. However, this disclosure is not limited in this regard. Additionally or alternatively, other generative models that may be used to create networks with communities. The extent of rewiring may be controlled by a user-provided parameter p_{B}∈(0, 1], configured to define a variance of the generated weights distribution. It may be appreciated that, as p_{B} approaches 1, the rewired networks become more like each other, and the original noisy network.

Given the basic noisy parameters of such a network, including lists of nodes, weighted degrees of all nodes, communities, and hierarchy, the generator is configured to produce a set of randomly generated networks by randomly redirecting weak edges while preserving the strong edges. In the process of generating a vast number of statistically equivalent networks, the generator may be configured to record an associated network structure for each unique network variant. Any duplicates of an already recorded network are configured to increase the duplicate count for this network.

When all networks are generated, each unique network may be treated as a solution variant and a probability that this variant represents the ground truth may be assigned to the variant. In an embodiment, this probability may be approximated by a ratio of the count of this network's duplicates plus one to the total number of all generated networks. Variants having relatively large occurrence counts may then correspond to networks with the most persistent patterns of network structures. In an embodiment, using Shannon entropy, a variant may be selected configured to minimize the uncertainty for operations planned on the network. Repeatedly generating new pools of networks from the resultant variant is configured to reduce the entropy of the result. Additionally or alternatively, if the entropy or the cost of distortions is relatively too high, the network operators can identify nodes, monitored for which can fastest reduce the entropy.

It may be appreciated that the entropy-based metrics, as will be described in more detail below, may be applied to a set of s community structures derived from r networks generated by the BWRN algorithm. Entropy-based metrics may be used to measure the uncertainty arising from two probabilities assigned to each node. As used herein, structural uncertainty corresponds to being a member of a community, and functional uncertainty corresponds to performing the function assigned to this node. These uncertainties may be measured in the set of generated community structures and functions assigned to nodes. A goal is to construct a community structure with a relatively lowest expected cost of operating on a network with uncertain communities and node functions caused by noisy network data. Two heuristics configured to create such community structures will be described in more detail below. These heuristics may be used in an investigation of criminal or terrorist organizations and may further be used to aid planning their disruptions

In an embodiment, noisy network data may be preprocessed. A Shannon entropy metric may be related to a probability that a community structure corresponds to the ground-truth community structure.

In an embodiment, given a network with a set N of nodes, denoted as {n₁, n₂, . . . , n_{|N|}}, and a set E⊆N×N of edges, the BWRN generator, as described herein, may be used to rewire the given network r times, creating a set of r networks which are statistically equivalent to each other. The Louvain community detection algorithm, as described herein, may then be used to detect (i.e., identify) non-overlapping communities in each generated network. The networks may then be clustered (i.e., grouped) into s≤r groups, each containing a same community structure Cᵢ for i=1, . . . , s. Each community structure Cᵢ has a respective corresponding weight wᵢ defined as the number of networks that share this structure.

The set of s identified community structures may then used as a proxy for the ground-truth community structure for the given noisy network data. It may be appreciated that when r→∞, fractions

$${f}_{i}^{C} = \frac{{w}_{i}}{r}$$

may asymptotically converge to the probability that the community structure Cᵢ is the ground truth for the given noisy network data.

The preprocessing operations utilize two user-definable parameters: p_{B}, which controls the extent of rewiring, and r, which defines the number of generated networks. It may be appreciated that as p_{B} is decreased, r may be increased. Relatively more aggressive rewiring may be associated with generating more networks to create all feasible community structures.

A method according to the present disclosure may be configured to utilize an entropy-based metric. A first entropy-based metric corresponds to the classic Shannon entropy determined over a set of generated community structures by setting

$${p}_{i}^{C} = {f}_{i}^{C} .$$

The corresponding equation is:

$${e}_{s}^{C} = {{\sum }^{s}}_{i = 1} {p}_{i}^{C} ln {p}_{i}^{C} \qquad ( 1 )$$

It may thus be appreciated that a relatively more reliable ground-truth structure corresponds to the community structure Cᵢ with a relatively highest fraction

$${f}_{i}^{C} .$$

One or more entropy metrics may be applied to noisy network data, as described herein. By way of theoretical background, three entropy-based metrics were developed related to human mobility. For human mobility, a user's location may be tracked based, at least in part, on the user's mobile telephone. In particular, a plurality users' locations may be tracked by identifying cell towers servicing the call of each user as the location. Uncertainty of user location may be defined by three entropy metrics for increasingly complex mobility patterns of the cell towers servicing the calls. A first entropy metric is random entropy defined as:

$${S}_{i}^{rnd} = {log}_{2} {V}_{i} , \qquad ( 2 )$$

where Vᵢ is the number of distinct locations (cell towers) visited by user i. A second entropy metric is temporal-uncorrelated entropy, defined as:

$${S}_{i}^{unc} = - {\sum }_{j = 1}^{{V}_{i}} {p}_{i} ( j ) {log}_{2} {p}_{i} ( j ) , \qquad ( 3 )$$

where pᵢ(j) is the historical probability that location (cell tower) j was visited by user i. A third entropy is the real entropy Sᵢ, which is related to a frequency and order of visits made by each user. Tᵢ=X₁, X₂, . . . , X_{L} denotes a sequence of cell towers at which that user i was observed at each consecutive hourly interval. Then, the real entropy is:

$${S}_{i} = - {\sum }_{{T}_{i}^{′} ⊂ {T}_{i}} P ( {T}_{i}^{′} ) {log}_{2} [ P ( {T}_{i}^{′} ) ] , \qquad ( 4 )$$

where

$$P ( {T}_{i}^{′} )$$

is the probability of finding a particular time-ordered subsequence

$${T}_{i}^{′}$$

in the trajectory Tᵢ.

Continuing with the human mobility example, a number of measures of predictability were provided. A first measure of predictability may be determined as Π≤Π^{max}(S, V), where Π^{max} represents a maximum predictability for each user, and may be determined as:

$$S = H ( {Π}^{max} ) + ( 1 - {Π}^{max} ) {log}_{2} ( V - 1 ) , \qquad ( 5 )$$

where the binary entropy function is:

$$H ( {Π}^{max} ) = - {Π}^{max} {log}_{2} ( {Π}^{max} ) - ( 1 - {Π}^{max} ) {log}_{2} ( 1 - {Π}^{max} ) . \qquad ( 6 )$$

A maximum predictability for Π^{rnd} and Π^{unc} may also be determined and extracted from

$${S}_{i}^{r n d} and {S}_{i}^{u n c} ,$$

In an embodiment, the human mobility entropy metrics may be adapted to generating network variants from a noisy network. For example, for real entropy, S, each node may be mapped onto a respective mobile user. Time slot t in the mobility model may be mapped to community structure Cₜ, where the node nᵢ visits all cell towers associated with members of its community in Cₜ, during time slot t. An order of visitations from the most to least frequent pairings between the node nᵢ and each member of its communities may be implemented. In other words, node nᵢ will first visit its community member nⱼ that most frequently appears with nᵢ in the same communities across all s community structures.

By way of further theoretical background, a community associated with a smallest expected cost of structural and functional uncertainties may be selected. The entropy measures may be used to find a community structure C^{can} with a relatively highest approximated probability to be the ground-truth structure and thus having the lowest entropy. A structure configured to provide a lowest expected cost of operating on a network with uncertain communities and node functions may be determined. This cost, [symbol] may be defined by a pairwise comparison of a newly constructed k version of a candidate community structure

$${C}_{k}^{c a n}$$

to each of the s already established structures Cᵢ. This cost can be defined as:

$${\text{?}}_{T} ( {C}_{k}^{can} ) = {\sum }_{i = 1}^{s} \text{?} ( {C}_{k}^{can} , {C}_{i} ) \qquad ( 7 )$$

As an illustrative example configured to demonstrate how to construct such cost functions, two simple but useful examples of them using pairs of community structures

$${C}_{k}^{c a n} ,$$

Cᵢ, shown in Equation (7) are introduced. A first cost function may be named frequency-based as it is configured to account for an average frequency of pairs of nodes appearing in all ground-truth communities. The frequency-based cost function may be defined as:

$${\text{?}}_{freq} ( {C}_{k}^{c a n} , {C}_{i} ) = {\sum }_{j = 1}^{\vert N \vert} ( \vert {c}_{k , j}^{c a n} ⋃ {c}_{i , j} \vert - \vert {c}_{k , j}^{c a n} ⋂ {c}_{ij} \vert ) {f}_{i}^{C} , \qquad ( 8 )$$

where

$${c}_{k , j}^{c a n}$$

denotes the community with the node nⱼ in

$${C}_{k}^{c a n}$$

and c_{i,j} refers to the community with node nⱼ in community structure i. Thus, this metric is configured to penalize unmatched members of either community with a unit cost, independent of the community size.

A second cost function, termed a fraction-based cost, is defined as:

$${\text{?}}_{frac} ( {C}_{k}^{c a n} , {C}_{i} ) = {\sum }_{j = 1}^{\vert N \vert} ( 1 - \frac{\vert {c}_{k , j}^{c a n} ⋂ {c}_{i , j} \vert}{\vert {c}_{k , j}^{c a n} ⋃ {c}_{i , j} \vert} ) {f}_{i}^{C} , \qquad ( 9 )$$

Thus, this metric is configured to determine an arithmetic complement of the Jaccard similarity metric between pairs of communities that share a node in the corresponding communities

$${C}_{k}^{c a n} ,$$

Cᵢ. Unlike the frequency-based cost function, the fraction-based cost function is configured to discount the expected cost of unmatched nodes in relatively large communities.

In both cases, the heuristics for creating C^{can} start with the initial C_{can,1} in which each node nⱼ∈N is a community. Let Mⱼ denote the average number of members of communities containing node nⱼ in all s ground-truth community structures. Then, the total penalty for the initial structure

$${C}_{can , 1} is - \vert N \vert + {\sum }_{j = 1}^{\vert N \vert} {M}_{j}$$

for the frequency-based penalty. Denoting m_{i,j} the number of members of a community containing node nⱼ in the Cᵢ community structure, the fraction-based penalty can be expressed as

$$\vert N \vert - {\sum }_{j = 1}^{\vert N \vert} {\sum }_{i = 1}^{s} \frac{{f}_{i}^{C}}{{m}_{i , j}} .$$

For the frequency-based penalty, the average frequencies of all pairs of nodes in all s feasible ground-truth community structures are determined and are denoted fₚ(j₁, j₂). Consequently, the change in penalty from joining j₁, j₂ into one community is p_{c}(1−2fₚ(j₁, j₂) and the penalty decreases when fₚ(j₁, j₂)>1/2. This argument holds if we apply it to communities cₐ, c_{b} and consider the frequency of their union cₐ∪c_{b}. This observation motivates our heuristic, defined inductively as follows:
1. Initial step 1, the initial C_{can,1} is the set of |N| communities, each containing a different single node.
2. Inductive step 1<k≤|N|. Having a community structure with |N|+2−k, the penalty change may be measured from merging any pair of communities. Next, the pair of communities

$${i}_{1}^{can} , {i}_{2}^{c a n}$$

with the lowest penalty change p_{c} in the merger may be selected. If p_{c}≤0, then the current community structure C_{can,k-1} is the best. Otherwise, communities

$${i}_{1}^{can} , {i}_{2}^{c a n} ,$$

may be merged, creating the

$${C}_{k}^{c a n}$$

structure with one less community that is merged with another, which is with |N|+1−k communities. It may be appreciated that this heuristic runs at most |N| steps.

The heuristic for the fraction-based penalty is configured to use the same inductive scheme of merging one pair of communities in each step, selecting a pair whose merging decreases the penalty the most, and stopping when none decreases the penalty.

In an embodiment, to improve computational efficiency, a dictionary of all s community structures may be created. Frequencies may then be recomputed for a pair of the candidate communities that were merged, which sped up the processing 100 times compared to the initial prototype.

### Experimental Data

The real-world Caviar gang and Sicilian mafia criminal networks and the Jakarta Bombing terrorist network were utilized in experiments to illustrate operation of the methods described herein.

The Caviar network represents criminals who smuggled hashish and cocaine into Montreal, Canada. The data were collected between 1994 and 1996. During this time, the police seized shipments of drugs but delayed any arrests until the investigation was completed. The Caviar network is a weighted and directed network, where edges represent wiretapped telephone calls between members of the network.

The Sicilian network was a drug-trafficking criminal organization based in Sicily, Italy. Its data was collected between 2003 and 2007. This network is also weighted and directed, with edges representing wiretapped telephone calls among members of the network. Both the Caviar and Sicilian networks were derived from data publicly released from court proceedings.

The Jakarta Bombing terrorist network is an undirected weighted network composed of two snapshots showing the network before and after the 2009 Jakarta bombing in Jakarta, Indonesia. Experiments were performed directed to the pre-attack snapshot because the network was denser before rather than after the attack.

In the experiments, the user-definable parameters: p_{B}, which controls the extent of rewiring, and r, which defines the number of generated networks were fixed at p_{B}=0.875 and r=1000, respectively. The network variants were generated using the BWRN generator, and the Caviar and Sicilian criminal networks and the Jakarta Bombing terrorist network. The Shannon entropy and the set entropy across the community structures of the rewired networks were then measured.

It may be appreciated that the user-defined p_{B}∈(0, 1] controls the variance of the generated weights distribution of the BWRN rewired networks. As p_{B} approaches 1, the rewired networks become more statistically equivalent to the original network. The effects of p_{B} on the resulting Shannon entropy values were evaluated for p_{B}: [0.5, 0.75, 0.875, 0.9375]. Table 1 shows the resulting Shannon entropy values. As p_{B} increases, the Shannon entropy mean and standard deviation of the community structures generated by BWRN decrease. In one nonlimiting example, p_{B}=0.875 results in rewired network community structures with the largest range of Shannon entropy values, in comparison to the rest of the tested p_{B} values. IT may be appreciated that networks rewired using p_{B}=0.875 may be more statistically equivalent to the original network than networks rewired using smaller p_{B} values, as shown in Table 1. Using p_{B}=0.9375, or a larger value, results in the rewired networks and the original network becoming too alike. Therefore, for the rest of this paper, all the BWRN rewired networks will use p_{B}=0.875.

Table 1 includes mean, range, and standard deviation of Shannon entropy for all community structures found in networks rewired from the original Caviar, Jakarta, and Sicilian networks using values of p_{B}=[0.5, 0.75, 0.875, 0.9375]. Each of the original networks was rewired 1000 times and divided into 10 groups with 100 networks each, to create 10 groups of results.

TABLE 1

| | p_{B} Values | 0.5 | 0.75 | 0.875 | 0.9375 |
|---|---|---|---|---|---|
| Caviar | mean | 3.640 | 3.246 | 2.727 | 2.169 |
| | range | 0.554 | 0.522 | 0.417 | 0.324 |
| | σ | 0.188 | 0.153 | 0.136 | 0.121 |
| Jakarta | mean | 2.043 | 1.379 | 0.944 | 0.621 |
| | range | 0.517 | 0.413 | 0.215 | 0.141 |
| | σ | 0.174 | 0.148 | 0.060 | 0.039 |
| Sicilian | mean | 6.908 | 6.908 | 6.907 | 6.826 |
| | range | 0 | 0 | 0.002 | 0.003 |
| | σ | 0 | 0 | 0.001 | 0.001 |

The rewiring of the Caviar and Sicilian networks using the BWRN generator results in creating networks with varying edges and community structures. Operations configured to find a community structure with the lowest Shannon entropy may begin with rewiring the original network r times. In the set of rewired networks, the community structure C^{can} with the highest fraction

$${f}_{i}^{C}$$

may be identified and all rewired networks with this community structure marked as candidates. Each candidate network may be rewired r times using the BWRN generator and the candidate network that results in the set of rewired networks with the lowest Shannon entropy may be marked as g^{can}. This process may be repeated iteratively on the sets of networks rewired using the subsequent g^{can}. This process stops when the Shannon entropy of the newly rewired network community structures stops decreasing. Once this happens, the process may be repeated one more time, and if all newly rewired networks have a Shannon entropy higher than the previous minimum, operations may stop. Otherwise, the rewiring may be restarted to search for the next local minimum of the Shannon entropy, and after finding it, operations stop. It may be appreciated that the Shannon entropy of the networks rewired from the subsequent graph g^{can} tends to be lower than that of the networks rewired from the original network.

The set entropy-based metrics may then be used to measure the uncertainty present across the community structures of all the rewired networks. Over the first few rounds of rewiring, the Shannon entropy and the set entropy are constantly decreasing, until they reach a minimum value. Once this happens, further rewiring would cause the Shannon entropy and set entropy to increase. It should be noted that further rewiring of the resulting networks with an increased entropy value brings back previously observed minimum values of the Shannon entropy and set entropy.

The presence of many candidate networks to rewire among the networks rewired from the original network may indicate that the original network has low uncertainty, resulting in many networks with the same community structure. Rewiring of O(r) networks r times, each with N nodes and L edges, takes O(r2gNL), where g is the cost of generating a random number. For a larger r, rewiring all candidates may be computationally challenging. In an embodiment, to continue the process of rewiring efficiently, a single network may be selected that has the highest modularity, in addition or alternatively to rewiring. Because the complexity of modularity is O(NL), the heuristic complexity is O(rNL), so it is O(rg) faster than rewiring.

Starting with the rewiring of the original Caviar and Sicilian networks at step 0, the networks are rewired using the BWRN generator. Then, a candidate for the lowest Shannon entropy community structure is found, denoted C^{can}, and this structure's networks are rewired to find the one, g^{can}, whose rewired networks yield the lowest Shannon entropy. This process is repeated until the minimum Shannon entropy value of the results stops decreasing. The Caviar network creates several candidates g^{can} before getting to the solution. To speed up the process, one candidate network with the largest modularity among all candidates may be selected.

In the experiments, the set entropy of the networks generated from the best candidate network g^{can}, were analyzed. After each step of rewiring,

$${S}_{i}^{r n d} , {S}_{i}^{u n c} ,$$

ana Sᵢ and their corresponding Π^{rnd}, Π^{unc}, and Π^{max} over the set of rewired network community structures were measured. Experimental data suggests that

$${S}_{i}^{u n c}$$

and the corresponding predictability Π^{unc} are the most useful measures for structure uncertainty. The temporal-uncorrelated entropy considers the number of unique communities to which each node belongs in its community structures and its frequency of appearance in such communities. In the experiment, the Π^{unc} increased as the corresponding Shannon entropy value decreased. It should be noted that, in the experiments, the value of Sᵢ, and its corresponding predictability Π^{max}, are calculated based on the assumption that the user will visit the most frequent community members first. It is contemplated that these values may change under a different assumption for patterns of visitations.

In experiments to evaluate the quality of communities generated using fraction-based and frequency-based methods, the rewiring step that results in the minimum Shannon entropy value is found, i.e., identified. For the Caviar and Sicilian networks, this value can be reached repeatedly as rewiring continues, even when the entropy starts rising. For the experiments, the round of rewiring with the first iteration of rewiring at which the minimum Shannon entropy value is reached, is termed i^{can}. Operations proceed by applying the fraction-based and frequency-based community prediction methods on the set of rewired network community structures present in the rewiring step that directly precedes i^{can}. The predicted communities of the fraction-based method are termed C_{frac} and the frequency-based method as C_{freq}. For all the experiments conducted using the frequency-based method, a user-defined parameter Z is set to R/2.

During the iterative rewiring experiment described above, the set entropy and the maximum predictability of the set of rewired network community structures were measured. The three entropy measures used are

$${S}_{i}^{r n d} , {S}_{i}^{u n c} and {S}_{i} ,$$

and their corresponding predictability Π^{rnd}, Π^{unc}, Π^{max} were extracted. Experimental results suggest that as the Shannon entropy of C^{can} decreases, so does the set entropy of the best community structure among all rewired networks, signaling the corresponding predictability increases.

Continuing with the experimental data, the best candidate network g^{can} was used in the set of rewired networks created by the rewiring step that directly precedes i^{can}. It may be appreciated that using either the C_{frac} or the C_{freq} generates communities whose Shannon entropy is lower than communities generated by rewiring g^{can}. This suggests that the construction heuristic goes beyond the optimization achievable by the rewiring. It may be further appreciated that Π^{unc}, Π^{max} increase for the networks rewired using C_{frac} and C_{freq}. Experimental data illustrated that the usage of the C_{frac}-predicted communities results in the highest predictability for Π^{unc}, Π^{max} across the set of rewired network community structures. Accounting for both the frequency of occurrence between nodes in communities and the size of the communities in which the nodes occur together improves predictions of the community structure from the set of rewired networks.

Table 2 illustrates that rewiring the network g^{can} with the community structure C^{can} reveals the community structures with the lowest observed Shannon entropy value. Using the BWRN generator, g^{can} was further rewired using the C_{frac} and C_{freq.}-defined community structures in place of C^{can}. It may be appreciated that the minimum Shannon entropy value of the set of rewired network community structures decreased in such cases. Using the C_{frac}-defined community structure yields the set of rewired network community structures with the highest Π^{unc} and the Π^{max} predictability.

TABLE 2

| Community | Shannon | | | |
|---|---|---|---|---|
| Structure | Entropy | Π^{rnd} | Π^{unc} | Π^{max} |
| C^{can} | 0.067 | 22.29% | 46.95% | 80.54% |
| C_{frac} | 0.058 | 21.9% | 50.49% | 81.27% |
| C_{freq} | 0.061 | 21.33% | 52.39% | 81.6% |

Generally, this disclosure is related to entropy measures of network community structure uncertainty and their use to establish limits of such uncertainties, Π^{rnd}, Π^{func}, Π^{max}. Thus a pool of rewired networks may be searched for the one whose community structure has the lowest uncertainty. Additionally or alternatively, beyond this pool, when using the second heuristic, we assign each node may be assigned to communities and network functions in the way that minimizes the expected cost of data uncertainty.

Network uncertainty and/or downstream consequences resulting from erroneous edge assignment may vary widely depending on which nodes are assigned to communities or functions that are different than predicted. In the case of criminal covert networks, such uncertainty may lead to the arrest of a low-level gang member instead of the leader. To address this challenge, a method, according to the present disclosure, is configured to construct a community structure with the minimal expected cost of uncertainty of each node community membership and function. The cost function can be predefined or provided by the users based on the application. Three examples of such functions and a methodology that starts with noisy network data and maps nodes to communities and network functions that minimize the expected cost of data uncertainty have been disclosed herein.

It is contemplated that, an apparatus, method and/or system, as described herein may be applied to other domains in which networks are created from noisy data. Each domain corresponds to a respective network type. Other domains (i.e., network types) may include, but are not limited to, biomedical networks, and the resilience of supply chains. In biomedical networks, data collections return massive volumes of noisy data. For the resilience of supply chains, diverse participants may limit access to their proprietary data to preserve their competitive advantage.

In some embodiments, there is provided a method of generating a synthetic network variant. The method includes generating, by a preprocessor module, a set of r generated networks based, at least in part, on noisy network structure data. The method further includes identifying, by the preprocessor module, at least one nonoverlapping community in each generated network. Each community has an associated community structure. The method further includes grouping, by the preprocessor module, the generated networks into a number, s, of groups based, at least in part, on a respective community structure. Each member of a respective group contains the respective community structure. The method further includes determining, by the preprocessor module, a respective probability for each community structure. Each probability may be related to a respective estimated ground truth community structure.

In some embodiments, the method may further include identifying, by a network variant module, a community structure configured to minimize an expected cost of operating on a network having uncertainty in at least one of an associated community structure and/or a node function.

In some embodiments, the method may further include generating, by a network pool generator module, a plurality of sets of intermediate networks based, at least in part, on a set of input networks. Each input network includes a community structure having a highest estimated probability of corresponding to a ground truth community structure.

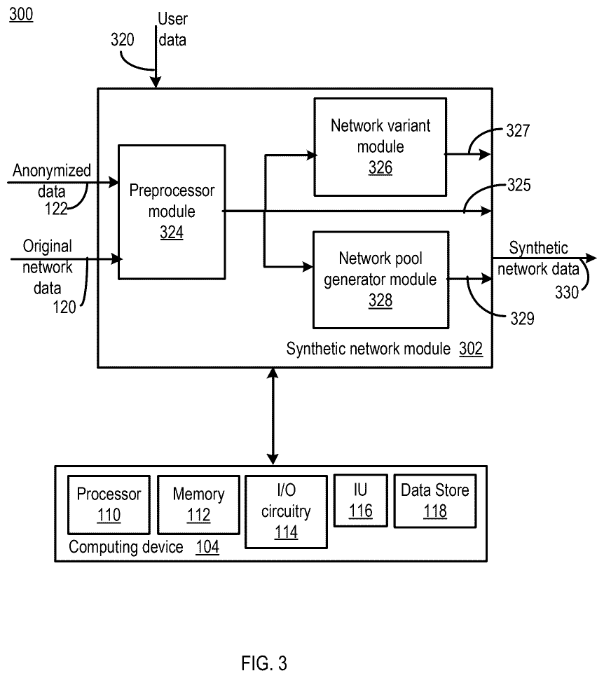

Turning now to FIG. 3, FIG. 3 illustrates a functional block diagram 300 of a synthetic network generator system for network analytics, according to several embodiments of the present disclosure.

Synthetic network generator system 300 includes a synthetic network module 302, and computing device 104. Synthetic network module 302 may be coupled to or included in computing device 104. Synthetic network module 302 includes a preprocessor module 324, a network variant module 326, and a network pool generator module 328.

Generally, the synthetic network generator system 300 for network analytics and/or the synthetic network module 302 is configured to receive original network data that may include and/or may have been corrupted by noise, as described herein. The synthetic network generator system 300 for network analytics and/or the synthetic network module 302 may be further configured to receive anonymized data 122 may include and/or may have been corrupted by noise, as described herein. Thus, noisy input data may include original network data 120 and/or anonymized data 122. The synthetic network generator system 300 for network analytics and/or the synthetic network module 302 may be further configured to receive user data 320, as will be described in more detail below.

The synthetic network generator system 300 for network analytics and/or the synthetic network module 302 may be further configured to provide as output synthetic network data 330. Synthetic network data 330 may include one or more of preprocessor output data 325, network variant output data 327 and/or network pool output data 329. The preprocessor module 324 may be configured to receive noisy input data (e.g., original network data 120 and/or anonymized data 122) and to provide as output preprocessor output data 325. The network variant module 326 and/or the network pool generator module 328 are configured to receive preprocessor output data 325 and to provide as output network variant output data 327 and network pool output data 329, respectively.

Processor 110 is configured to perform operations of synthetic network module 302. Memory 112 may be configured to store data associated with synthetic network module 302. I/O circuitry 114 may be configured to provide wired and/or wireless communication functionality for synthetic network generator system 300. For example, I/O circuitry 114 may be configured to receive original network data 120 and/or anonymized data 122, and to provide synthetic network data as output 330. Data store 118 may be configured to store one or more of original network data 120, anonymized data 122, synthetic network data 330 (e.g., preprocessor output data 325, network variant output data 327 and/or network pool output data 329), and/or user data 320.

In operation, the synthetic network generator system 300 for network analytics may be configured to perform one or more sets of operations, configured to produce one or more estimates of a ground-truth community structure, to generate new pools of networks from a network variant configured to minimize uncertainty in operations on a network, and/or to identify a network variant of a network structure configured to minimize uncertainty for operations planned on the network. In an embodiment, the sets of operations may include, but are not limited to, preprocessor operations, network variant operations, and/or network pool generator operations.

Operations of synthetic network module 302 and associated operations of preprocessor module 324, network variant module 326, and/or network pool generator module 328 are configured to construct a community structure for a given network while minimizing the expected cost arising from operating on networks with communities and functions distorted by using noisy data for their creation. Additionally or alternatively, a synthetic network generator system 300, according to the present disclosure, is configured to perform associated operations without a given ground-truth network and/or community structure.

A first set of operations may be performed by the preprocessor module 324. The preprocessor module 324 is configured to receive noisy network data, e.g., original network data 120 and/or anonymized data 122. The preprocessor module 324 may be further configured to preprocess the noisy network data to produce preprocessor output 325. Preprocessor output 325 may include one or more community structures and associated probabilities that a selected community structure corresponds to a ground-truth community structure.

Preprocessor module 324 operations may include retrieving and/or acquiring noisy network data and generating a set of networks based, at least in part, on the noisy network data. The set of networks may include a number, r, networks. In one nonlimiting example, the number of networks in the set may be on the order of one thousand. However, this disclosure is not limited in this regard and more or fewer networks may be generated. The number r of networks in the set is related to user parameter p_{B} related to variance, as described herein.

Preprocessor module 324 operations may further include identifying each nonoverlapping community in each generated network. Each community may have an associated community structure. A “nonoverlapping community” corresponds to a nonoverlapping community structure. Preprocessor module 324 operations may further include grouping the generated networks into a number, s, groups based, at least in part, on a respective community structure. Each member network of a respective group may then contain the respective community structure. Each community structure may have an associated weight defined as the number of networks that share that community structure, as described herein.

Preprocessor module 324 operations may further include determining a respective probability for each community structure. Each probability may correspond to a respective estimate of a ground-truth community structure. In an embodiment, the probability for each group may be determined as a ratio of a number of members of the group (i.e., the community structure weight) to the number, r, of networks in the set, as described herein. For relatively large r, the probability may correspond to a Shannon entropy value.

In an embodiment, processor output 325 may thus include the community structures (i.e., community structure data) as well as the associated probabilities that the community structures correspond to the ground-truth community structure.

A second set of operations may be performed by the network variant module 326. The network variant module 326 is configured to receive preprocessor output data 325 including community structure data, Cᵢ, for each of the number s groups of networks having a same community structure, as described herein. The network variant module 326 is configured to provide a newly generated community structure based, at least in part, on the community structures identified by the preprocessor module 324 operations. The newly generated community structure is configured to yield a relatively low (e.g., lowest) expected cost of operating on a network with uncertain communities and node functions. The expected cost may be modeled as a cost function, as described herein.

In an embodiment, a cost function may be constructed based, at least in part, on pairs of community structures, as described herein. In one nonlimiting example, the cost function may be defined by a pairwise comparison of a newly constructed version of a candidate community structure to each of the number s community structures identified by the preprocessor module 324. In an embodiment, a plurality of cost functions may be constructed, as described herein. In one nonlimiting example, a first cost function may be frequency-based, and a second cost function may be fraction-based. Each cost function may then correspond to a respective penalty, e.g., a frequency-based penalty and a fraction-based penalty, as described herein. A sequence of operations for determining a community structure for each penalty may be generally the same for both penalties while the particular cost functions differ.

Network variant module 326 operations may include repeatedly generating a set of candidate communities, and evaluating a corresponding penalty, until a stop criterion is met, e.g., a penalty stays constant for more than one iteration. The penalty is related to a comparison between each candidate community and a corresponding estimated ground-truth community structure. Initially, each candidate community may contain one node. For each iteration, network variant module 326 may be configured to merge pairs of communities and to determine a corresponding penalty change for each merger. network variant module 326 may be further configured to select a pair of communities corresponding to a lowest penalty change. If the penalty change is greater than or equal to zero, the current merged community structure corresponds to the network variant configured to minimize uncertainty for operations planned on the network. If the penalty change is not greater than or equal to zero (i.e., the penalty is decreasing), pairs of remaining communities may be merged and the process repeats until the stop criterion is met. It may be appreciated that these operations may be repeated for both the frequency-based penalty and the fraction-based penalty.

Thus, the newly generated community structure is configured to yield a relatively low (e.g., lowest) expected cost of operating on a network with uncertain communities and node functions.

A third set of operations may be performed by the network pool generator module 328. Network pool generator module 328 is configured to retrieve or acquire an initial set of r networks generated based, at least in part, on an initial input network. In one nonlimiting example, the BWRN generator, as described herein, may be used to generate a plurality of networks with varying edges and community structures. Network pool generator module 328 is further configured to identify an initial community structure corresponding to a highest probability fraction

$$( {f}_{i}^{C} )$$

and thus minimum Shannon entropy, and to select as candidate networks the generated networks that have the initial community structure. Network pool generator module 328 is then configured to generate a new pool (i.e., group) of networks based, at least in part, on the prior pool of candidate networks. Network pool generator module 328 is configured to repeat the identifying, selecting and generating, until the Shannon entropy stops decreasing with each iteration. Once the Shannon entropy stops decreasing, the network pool generator module 328 may be configured to perform one more iteration. If the Shannon entropy has resumed decreasing, the iterations may continue. If the Shannon entropy doe not decrease then operations may stop. In one nonlimiting example, the BWRN generator, as described herein, may be used to generate a plurality of networks with varying edges and community structures.

In an embodiment, each iteration of generating a new pool of networks is configured to run the BWRN generator a number, r, times on each candidate network associated with the community structure having the minimum Shannon entropy. In another embodiment, each iteration of generating a new pool of networks may be configured to run the BWRN generator a number, r, times on a selected candidate network having a relatively highest modularity. As is known, modularity corresponds to a fraction of edges that fall within a given group minus an expected fraction of edges for edges distributed randomly. Utilizing modularity is configured to reduce a computational cost.

Thus, a pool of networks may be generated configured to minimize uncertainty for operations on an associated network. It may be appreciated that the Shannon entropy of the networks generated from subsequent candidates, as described herein, tends to be relatively lower than the Shannon entropy of the original network.

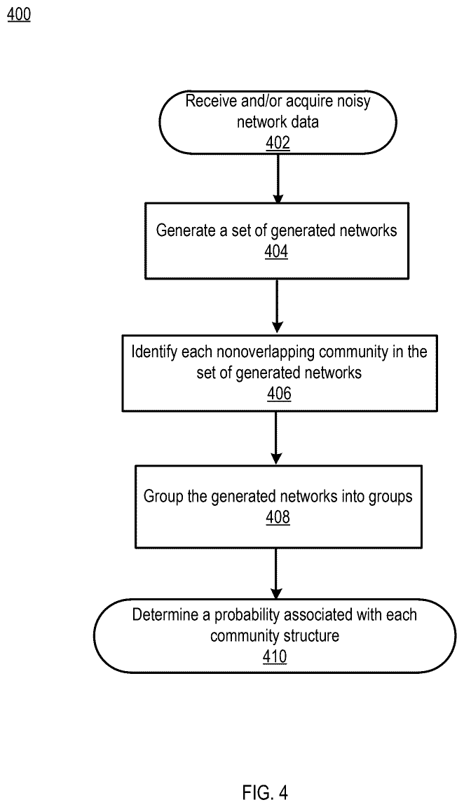

FIG. 4 is a flowchart 400 of preprocessing operations, according to various embodiments of the present disclosure. In particular, the flowchart 400 illustrates estimating a ground truth community structure based, at least in part, on noisy network input data. The operations may be performed, for example, by the synthetic network generator system 300 (e.g., synthetic network module 302 and/or preprocessor module 324) of FIG. 3.

Operations of this embodiment may begin with receiving and/or acquiring noisy network data at operation 402. Operation 404 includes generating a set of generated networks. Operation 406 includes identifying each nonoverlapping community in the set of generated networks. Operation 408 includes grouping the generated networks into groups. For example, each group may correspond to a same community structure. Operation 410 may include determining a probability associated with each community structure. For example, the probability may be determined based, at least in part, on a number of networks in each group. Each probability may be related to a respective estimated ground truth community structure.

Thus, an estimated ground truth community structure may be estimated based, at least in part, on noisy network data.

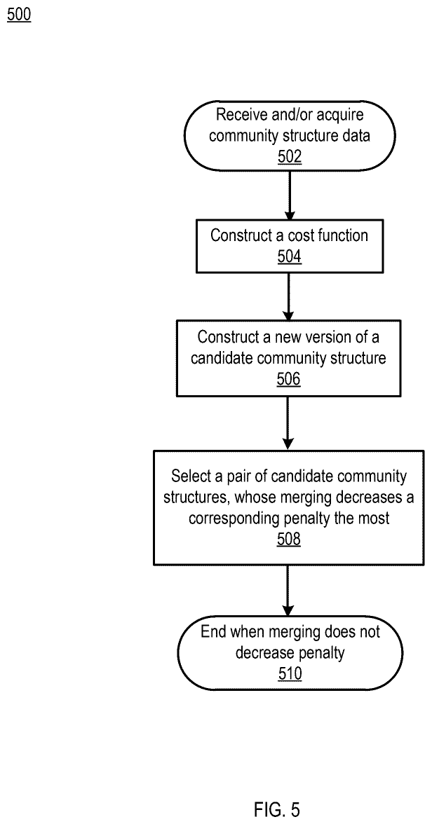

FIG. 5 is a flowchart 500 of network variant operations, according to various embodiments of the present disclosure. In particular, the flowchart 500 illustrates determining a community with a smallest expected cost of uncertainty. The operations may be performed, for example, by the synthetic network generator system 300 (e.g., synthetic network module 302 and/or network variant module 326) of FIG. 3.

Operations of this embodiment may begin with receiving and/or acquiring community structure data at operation 502. Operation 504 includes constructing a cost function. The cost function may correspond to a penalty. The cost function may relate a candidate community structure and existing community structure data. Operation 506 includes constructing a new version of a candidate community structure. For example, the new version may be constructed by merging to prior candidate community structures. Operation 508 includes selecting a pair of candidate community structures, whose merging decreases a corresponding penalty the most. Program flow may end at operation 510 when merging does not decrease penalty.

Thus, a community may be identified that has an associated relatively smallest expected cost of uncertainty.

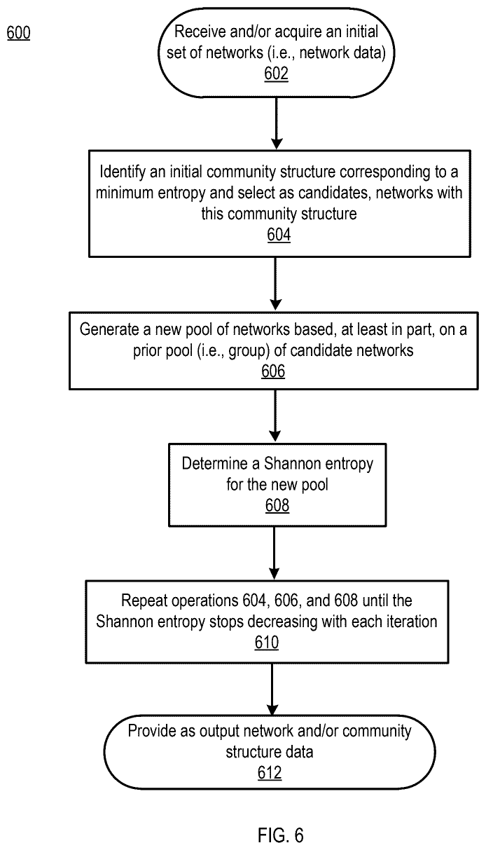

FIG. 6 is a flowchart 600 of network pool generation operations, according to various embodiments of the present disclosure. In particular, the flowchart 600 illustrates determining a community structure with a lowest Shannon entropy. The operations may be performed, for example, by the synthetic network generator system 300 (e.g., synthetic network module 302 and/or network pool generator module 328) of FIG. 3.

Operations of this embodiment may begin with receiving and/or acquiring an initial set of networks (i.e., network data) at operation 602. Operation 604 includes identifying an initial community structure corresponding to a minimum entropy and selecting as candidates, networks with this community structure. Operation 606 includes generating a new pool of networks based, at least in part, on a prior pool (i.e., group) of candidate networks. Operation 608 includes determining a Shannon entropy for the new pool. Operation 610 includes repeating operations 604, 606, and 608 until the Shannon entropy stops decreasing with each iteration. Operation 612 providing as output network and/or community structure data.

Thus, a community structure with a lowest Shannon entropy may be determined.

In an embodiment, a method of analyzing networks created from data with unintentional or intentional errors is disclosed, configured to improve downstream extraction of network features.

The presence of noise in network data distorts the detection of network edges, which is likely to modify the network's community structure. In the absence of the ground-truth data about basic properties of the network, including, for example, allocation of nodes to communities and to network functions, an operation designed based on a single network derived from such data may not be able to predict all distortions that can arise during such an operation.

Generally, this disclosure relates to preprocessing operations that are applied to collected noisy network data, three entropy-based metrics, and two heuristics, each of which constructs a community structure for a given network while minimizing the expected cost arising from operating on networks with communities and functions distorted by using noisy data for their creation.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A method of generating a synthetic network variant, the method comprising:
generating, by a preprocessor module, a set of r generated networks based, at least in part, on noisy network structure data;
identifying, by the preprocessor module, at least one nonoverlapping community in each generated network, each community having an associated community structure;
grouping, by the preprocessor module, the generated networks into a number, s, of groups based, at least in part, on a respective community structure, each member of a respective group containing the respective community structure; and
determining, by the preprocessor module, a respective probability for each community structure, each probability related to a respective estimated ground truth community structure.

2. The method of claim 1, wherein the probability is modeled as a ratio of a size of a respective group to the number, r, generated networks, the size corresponding to a weight associated with the corresponding community structure.

3. The method of claim 1, wherein the community structure associated with a largest respective probability corresponds to an estimated ground-truth community structure.

4. The method of claim 3, wherein the community structure having the largest respective probability corresponds to a lowest entropy community structure.

5. The method of claim 1, further comprising identifying, by a network variant module, a community structure configured to minimize an expected cost of operating on a network having uncertainty in at least one of an associated community structure and/or a node function.

6. The method of claim 1, further comprising generating, by a network pool generator module, a plurality of sets of intermediate networks based, at least in part, on a set of input networks, each input network including a community structure having a highest estimated probability of corresponding to a ground truth community structure.

7. The method of claim 1, further comprising generating, by a network pool generator module, a set of intermediate networks based, at least in part, on an input network, the input network including a community structure having a highest estimated probability of corresponding to a ground truth community structure.

8. The method of claim 6, wherein the input network has been selected from a set of input networks, the selected input network having a highest modularity relative to other input networks included in the set of input networks.

9. The method of claim 5, wherein the identifying the community structure configured to minimize an expected cost comprises at least one of a frequency-based penalty and a fraction-based penalty.

10. The method of claim 5, wherein the identifying the community structure configured to minimize an expected cost comprises iteratively merging a pair of candidate communities to yield a new candidate community and determining a penalty change associated with the merger.

11. A computer readable storage device, the device having stored thereon instructions that when executed by one or more processors result in the following operations comprising:
generating a set of r generated networks based, at least in part, on noisy network structure data;
identifying at least one nonoverlapping community in each generated network, each community having an associated community structure;
grouping the generated networks into a number, s, of groups based, at least in part, on a respective community structure, each member of a respective group containing the respective community structure; and
determining a respective probability for each community structure, each probability related to a respective estimated ground truth community structure.

12. The device of claim 11, wherein the probability is modeled as a ratio of a size of a respective group to the number, r, generated networks, the size corresponding to a weight associated with the corresponding community structure.

13. The device of claim 11, wherein the community structure associated with a largest respective probability corresponds to an estimated ground-truth community structure.

14. The device of claim 13, wherein the community structure having the largest respective probability corresponds to a lowest entropy community structure.

15. The device of claim 11, wherein the instructions that when executed by one or more processors result in the following operations comprising identifying a community structure configured to minimize an expected cost of operating on a network having uncertainty in at least one of an associated community structure and/or a node function.

16. The device of claim 11, wherein the instructions that when executed by one or more processors result in the following operations comprising generating a plurality of sets of intermediate networks based, at least in part, on a set of input networks, each input network including a community structure having a highest estimated probability of corresponding to a ground truth community structure.

17. The device of claim 11, wherein the instructions that when executed by one or more processors result in the following operations comprising generating a set of intermediate networks based, at least in part, on an input network, the input network including a community structure having a highest estimated probability of corresponding to a ground truth community structure.

18. The device of claim 16, wherein the input network has been selected from a set of input networks, the selected input network having a highest modularity relative to other input networks included in the set of input networks.

19. The device of claim 15, wherein the identifying the community structure configured to minimize an expected cost comprises at least one of a frequency-based penalty and a fraction-based penalty.

20. The device of claim 15, wherein the identifying the community structure configured to minimize an expected cost comprises iteratively merging a pair of candidate communities to yield a new candidate community and determining a penalty change associated with the merger.
